(19) United States
(12) Patent Application Publication
(10) Pub. No.: US 2009/0171857 A1
(43) Pub. Date: Jul. 2, 2009

(54) Method of increasing the sale value of the equity of a business entity

(76) Inventor: Durham Russell Maples, Camden, SC (US)

Correspondence Address: Durham Russell Maples, 1507 Park Circle, Camden, SC, 29020, US

(21) Appl. No.: 12/005,595

(22) Filed: Dec. 27, 2007

(51) Int. Cl. G06Q 40/00

(52) U.S. Cl. 705/36 R; 705/37; 705/35

(57) ABSTRACT

A business entity or investment entity increases the sale value of its own equity by forming a new hybrid investment unit that includes the combination of a debt instrument and the equity share. The debt instrument pays interest that is tax deductible to the business entity or investment entity and is not subject to the double taxation of dividends. The price of an ordinary equity share traded on an exchange is artificially reduced by the amount the cash dividend paid. The hybrid investment unit prevents the exchange from artificially reducing the equity in the unit because the debt in the unit pays interest and principal instead of dividends.

### REFERENCES CITED

### U.S. Patent Documents

U.S. Pat. No. 6,381,585 B1 Apr. 30, 2002 Maples et al. 705/36
U.S. Pat. No. 7,096,195 B1 Aug. 22, 2006 Maples 705/36

### Foreign Patent Documents

### PCT/US99/17242 Jul. 29, 1999 Maples G06F 17/60

### FEDERALLY SPONSORED RESEARCH AND DEVELOPMENT

Not Applicable

### OTHER PUBLICATIONS

### U.S. Tax Code-Sec. 1273 (c) (2)—Jul. 18, 1984

### U.S. Tax Code-Sec. 385—Amended Dec. 19, 1989

### U.S. Tax Code-Sec. 163—Aug. 16, 1954

### U.S. Tax Code-Sec. 149 (a) (3)—Oct. 24, 1986

U.S. Tax Code-Sec. 243 (a)—Aug. 16, 1954

### Universal Casting Corporation V. Commissioner of Internal Revenue 37 T.C. 107

### 1961 US Tax Court Decision Oct. 31, 1961 by Mulroney.

Registration under the Securities Act Of 1933

### Trust Indenture Act of 1939 Sec. 302

### Trust Indenture Act of 1939 Sec. 304

### Trust Indenture Act of 1930 Sec. 305

### InvestorWords.com Ex-Dividend Date Definition

### Trust and Asset Management Handbook Sec. 750 Introduction to Corporate Trust July 2001

What is a dividend? Posted by Blain Reinkensmeyer Apr. 12, 2007

### Fidelity Reorganizes; Move May Eliminate U.S. Taxes by Miles Weiss Nov. 2, 2007

### Nearly All Major Countries Provide Dividend Tax Relief by Chris Edwards Jan. 7, 2003

### Dividend Taxation; U.S. Has the Second Highest Rate by Chris Edwards Jan. 17, 2003

### STATEMENT REGARDING FEDERALLY SPONSORED RESEARCH OR DEVELOPMENT

Not Applicable

### BACKGROUND

1. Field of Invention

This invention relates to the field of financial securities, investment banking, tax law, stock exchanges and securities law.

2. Discussion of Prior Art

Corporations have been looking for ways to reduce the amount of taxes they have to pay ever since corporate taxes were introduced. This is evidenced by numerous tax shelters that corporation's employ including stock options. Stock options allow the corporation's the ability to pay employees with stock instead of cash and to have a carry forward tax shelter. One form of taxation that is a particular problem for corporation's is the double taxation on cash dividends paid to shareholders. Corporations want to pay cash to their shareholders to help increase or maintain their own stock value.

Corporations also look for ways to increase or maintain their stock value because it is their market value. The stock value is not just valuable to the corporation when it is first sold to the shareholders but the outstanding value of the stock is also important to the corporation. The higher a corporation's stock value, the less likely that another corporation will be able to afford to buy the stock in any unfriendly take over. The value of the outstanding stock determines the value of any new shares to be sold or traded. The more valuable the outstanding stock the, easier it is to borrow money at lower interest rates. The more valuable the newly sold stock, the more money the corporations receive.

Paying cash dividends to the stock, and by extension the shareholders, is a proven method of increasing or maintaining the corporation's stock value. However, the fact that the corporation cannot deduct the cash dividend payment from their corporate taxes makes it more difficult to pay these cash dividends. There is also the major problem of stock exchanges deducting the dividend cash amounts from the value or share price of the stock. This hurts the corporation's market value and hurts the shareholders property value. A new method of paying cash to shareholders that is tax deductible to the corporation and that stock exchanges do not deduct the cash amount from the share value or price is needed.

Despite the problems with paying dividends, corporations still pay cash dividends to shareholders in huge amounts every year. The corporations are aware that paying a dividend makes it more likely that shareholders will not sell their stock even when it is going down in price because they are essentially paying the shareholders to wait for the stock price to go up. Corporations are trying to relieve the double taxation by changing their corporate structure as evidenced by the Fidelity reorganization. The Bloomberg Fidelity reference explains that Fidelity Investments has reorganized its corporate structure to eliminate the double taxation. Even if it costs a one-time capital gains levy the corporation obviously realizes that it will pay off in the future.

Fidelity took matters into their own hands and did not wait for the government to abolish the double taxation on dividends. The U.S. has the second highest dividend rate of all thirty nations in the Organization for Economic Cooperation and Development as of January 2003. This was probably lowered with the later in the year with the Bush tax cuts but the dividend tax cut is scheduled to end in December 2008. This means the higher rates will be back into effect then and U.S. corporations will continue to have difficulty competing with corporations in other countries. Only Ireland, Switzerland and the U.S. are the only countries in OECD that do not offer relief from dividend double taxation. Ireland and Switzerland have lower corporate income tax rates, 12.5 percent and 24.5 percent, respectively. The result is a lower overall tax burden in those countries than in the U.S.

With these facts in mind the investment banking profession is always looking for new forms of financial securities that can raise money for corporations or other financial entities. The investment banking companies have financial product engineers who are constantly looking for better securities that raise more money for corporations and in turn increase the investment banking fees. The financial securities must comply and operate within the tax law and the securities law.

The investment banking financial product engineers would have a very lucrative market for a security that allowed the corporation to pay cash to shareholders that was either tax deductible to the corporation, or that the cash would not be included in the shareholder's taxable income. Secondly, the cash amount paid to the shareholders would not be deducted from the share or value of the stock by the stock exchange on which the stock was being traded. Thirdly, cash paid to the shareholders would not have a partial tax exemption specifically for corporations. Under Sec. 243 of the tax law, dividends paid to a corporation by another corporation are 70% tax free for the corporation receiving the dividend. The tax exemption rises to 80% if the corporation owns at least 20% of the voting stock of the corporation paying out the cash dividend.

Any investment banking group that could engineer a financial security that was a unit or share of equity but paid cash to the shareholder that was not a dividend would accomplish the removal of the corporate dividend tax exemption. If cash, other than a dividend, were paid to the shareholder then stock exchanges would not have legal grounds to deduct a non-dividend cash amount from the unit or share price.

The tax law is not kind to dividends because it does not allow the corporation paying the dividend a tax deduction. The tax law does allow the interest paid on indebtedness to be tax deductible to the corporation. The creditor must pay taxes on the interest received but not on the amount of principal that is lent to the corporation. The investment banking group could engineer a security to pay interest to the shareholder instead of paying dividends then the corporation would be able to deduct the interest payment and reduce their taxes. Paying interest instead of dividends would prevent the corporate dividend tax exemption as well.

Sec. 385 of the U.S. tax code allows for an interest in a corporation to be in part stock and in part indebtedness. The implication is that a single instrument is both debt and stock. This is really not operationally possible under the current tax law. A debt instrument must have a point or specified date when the principal amount of the debt is paid off. Stock can operate without being redeemed for as long as the business entity operates. To have a single instrument to function as both stock and debt would require that at least one debt instrument is combined or joined with at least one equity instrument. This would create or form a hybrid instrument that would be a single instrument that would function as both stock and debt but they would be functioning as separate instruments within a single unit. Sec. 1273 (c) (2) of the U.S. tax code mentions such a hybrid instrument. The description of the investment unit is very non-specific and simply states “In the case of any debt instrument and an option, security, or other property issued together as an investment unit-”. A security or other property would include stock or equity.

This reference was disclosed in PCT/US99/17242 and U.S. Pat. No. 6,381,585 B1 and U.S. Pat. No. 7,096,195 B1 that dealt with an invention called a Share Bond. The patents were describing a non-investment bond that was designed to enhance the equity of a business entity. The invention in this application would be an investment bond and would be used to raise money or capital for the business entity or even an investment entity. The Share Bond is specifically a non-investment bond that the shareholder could not exchange for any money or property. The new invention will be a share or unit of equity that will be an investment stock and will be joined with or to a bond that will have the shareholder exchanging money, property ownership or the right to use property for the bond. The new invention will be called a HyShare as a hybrid share of equity. The HyShare will be different from the Share Bond in that a shareholder can own the HyShare debt in the investment unit. The shareholder can never own a Share Bond and the Share Bond rights are issued to outstanding stock. The HyShare debt instrument can be issued to the stock or issued to the individual. The Share Bond can never add any money or property ownership to the business entity. The business entity always receives full consideration in money or money's worth for the HyShare debt in the HyShare investment unit. The Share Bond could only receive adequate consideration in money's worth in the form of stock enhancement Stock enhancement is maintaining or increasing the value of the stock. The patent references disclose only that the stock enhancement comes from the people in the stock market favoring the stock more because of the guaranteed payments, advanced schedule of payments, and paying interest allows the business to pay more than dividends. The Share Bond maturity was limited to less than 5 years because it could not receive full consideration and that the consideration could not be verified to the penny. The time limitation is based on Sec. 163 (i)(1) regarding debt with a significant original issue discount. Unlike the Share Bond the debt element in the HyShare investment unit can have a maturity date in excess of 5 years.

The reason for this is that the debt element in the HyShare unit receives full consideration in money or property ownership that can be verified to the penny. The debt element in the HyShare unit has the flexibility of receiving full consideration in the form of the right to use the property of the shareholder that can be verified to the penny. When the owner or shareholder of the equity included in the HyShare investment unit is paid interest or principal the stock exchange has no legal reason to deduct the amount of interest or principal from the share price. The business is not paying a dividend so there will not be an ex-dividend reduction of the share or equity price.

The applicant has coined the phrase ex-dividend reduction to describe what the stock exchanges do when they are subtracting the amount of the dividend from the stock price. The action of the stock exchanges is not widely known or discussed. Most people are not aware that this occurs. The HyShare invention can take advantage of this reduction when the business entity pays interest to the shareholder of the HyShare and the stock value of the business entity is not reduced. This is a “verifiable to the penny” exchange that the business entity receives for the principal amount the business entity is promising to pay at a later date. The business entity using the HyShare investment unit can receive this benefit every time the interest or principal is paid to a shareholder, which will maintain the market value of the business entity. The business entity can use this aspect to allocate all the money that is exchanged for the unit to the stock. This creates a better debt to equity ratio for the business entity. The HyShare investment unit uses the debt to help the business raise more money by selling this unit.

The investment unit disclosed in Sec. 1273 is not specific on how the unit would operate only that any debt instrument and a security (stock) are issued together in an investment unit. Also the issue price of the debt instrument would be the market value of the debt element in the unit. The HyShare invention includes specifications not disclosed in Sec. 1273 as will be discussed further in the application.

### OBJECTS AND ADVANTAGES

A) The main objective of the invention is to create a superior investment instrument that the investment banking profession can offer to corporations for their initial sale of stock.

B) Creates a superior instrument that investors will prefer to invest in than ordinary stock.

C) Creates a superior instrument that raises more money for the corporation than ordinary stock.

D) Removes the double taxation for corporations.

E) Removes the double taxation for shareholders.

F) Gives shareholders cash return on investment within the first year of owning stock.

G) Allows a corporation or other business entity to annually pay cash to shareholders or unit holders without a stock exchange deducting the amount equal to the cash amount from the share price that eliminates the devaluation of the corporation's or other business entity's market value.

H) Allows the shareholder to receive cash from a corporation or other business entity without a stock exchange deducting the amount equal to the cash amount from the share price that eliminates the devaluation of the shareholder's property.

I) Allows the corporation to allocate the full amount of the sale cash or property to the equity element in the investment unit and still receive full consideration in money's worth for the debt element in the investment. The corporation receives the right to use the equity property of the shareholder and not have the stock exchanges devalue the corporation's market value. The shareholder receives the written unconditional promise to receive a sum certain in money on a future specified date.

J) Allows the shareholder of record to receive the payment of the principal tax free to the shareholder of record if the initial shareholder paid money or property for the debt instrument element in the investment unit.

K) Allows the corporation to increase the equity in the debt to equity ratio by allocating money received on the sale of the unit to be allocated entirely to the equity.

L) Allows U.S. corporations to compete better financially with international corporations.

### SUMMARY OF INVENTION

The invention has been engineered to aid a corporation or investment entity in raising more money than can be accomplished by selling a pure equity instrument. The new hybrid investment unit has all the benefits of equity ownership and adds the benefits of debt. The first benefit is that the corporation or investment entity can pay interest that is not subject to double taxation. The second benefit is that by paying interest or principal instead of dividends, the stock exchange does not reduce the equity price by the amount of money paid out. The third benefit is that the equity will maintain its market value better for the corporation. The price of the equity will be subject to market forces but not artificial reductions in price when money is paid to the equity holder. The debt instrument and the equity will be issued together and will be traded together until the debt matures and the principal is paid to the shareholder of record.

### DETAILED DESCRIPTION OF INVENTION

A business entity forms a hybrid investment unit that includes a debt instrument and a share of equity or stock. The business entity or corporation issues a written unconditional promise to pay a sum certain in money on a specified date (principal) and to pay interest until the sum certain in money is paid. The debt instrument and the share of stock are joined together in this investment unit by several methods.

Mechanism 1 the business entity or corporation transfers in writing the right to the principal and interest of the debt instrument to the share of stock. In this mechanism the rights to the debt instrument are stapled or coupled, in writing, to the stock to form the investment unit. The rights to the debt instrument must be issued to the stock because the stock must be owned and could eventually be the only surviving element since the debt will mature. These rights cannot be sold or traded separate from the stock. This information will be contained in any Securities and Exchange Commission registration or in the sale prospectus for the investment unit.

Mechanism 2 the business entity or corporation and an investor have a written agreement that the debt instrument and the share of stock will be sold and traded together in an investment unit. The corporation can also have unilateral agreement that states the debt instrument and the share of stock will be sold together as an investment unit in the Securities and Exchange Commission registration or the sale prospectus for the HyShare investment unit.

In both mechanisms the corporation will prohibit both in writing and in action the debt instrument and the share of stock from being sold or traded separate from each other. The bond principal amount multiplied by the number of operational bonds will be placed on the debit side of the corporation's balance sheet as debt. The same amount will be placed on the credit side of the balance sheet as elimination of the corporation's market value devaluation. The corporation cannot amortize this aggregate principal amount. The debt instrument can be joined to the stock in any ratio but one debt instrument to one share of stock is the best. This 1:1 ratio forms the encapsulated investment unit that operates in a more simplified manner.

The interest rate can be from 0.01% and higher. The best rate would be about 100%. The HyShare investment unit can pay a high yield and still have a term longer than 5 years because the corporation always receives full consideration for the debt. The HyShare can never have a significant or any original issue discount that applies in Sec. 163. When the interest payment is paid out, the interest amount multiplied by the number of operational bonds will be placed on the debit side of the corporation's balance sheet as an income deduction. The same amount will be placed on the credit side of the corporation's balance sheet as elimination of the corporation's market value devaluation. The corporation can pay out the interest without the stock exchanges deducting the interest amount from the share price and therefore, the corporation's market value is not devalued. The corporation will be able to deduct the amount of interest paid out from the corporation's gross income annually.

The HyShare will operate best if registered with the Securities and Exchange Commission, providing a full disclosure of how the debt instrument and the share of stock are issued together in the hybrid investment unit. The document will explain how the hybrid investment unit operates. The same disclosure and explanation will be written in a sale prospectus used to sell the new hybrid investment unit securities.

The debt element will best operate as a book entry bond that transfers the right of the principal and interest on the debt element to the shareholder of record. If the debt element aggregate principal amount is $10,000,000 or more the Securities and Exchange Commission will require there be an Indenture Trustee. The Indenture Trustee or their agent is to be responsible for making the proper transference of rights from the debt element to the shareholder of record of the equity element in the HyShare investment unit. The Indenture Trustee, or their agent, that is entrusted with this transference and will receive a list of the shareholders of record for the ex-interest dates and for the ex-principal dates from a stock transfer agent. The list will include the number of shares of stock of the HyShare investment units each one owns. The Indenture Trustee or their agent will make the appropriate calculations and pay the appropriate people or entities the correct amount of money. The Indenture Trustee monitors the debt element default provisions in the written agreement or rights transfer. The Indenture Trustee or their agent performs all of these duties and others outlined in the Introduction to Corporate Trust reference. This includes preparing and issuing checks for payment of interest and principal.

The business entity or investment entity deposits the necessary payment amount into the appropriate account from which the issued checks will be drawn. Since the payment is interest or the principal from the debt element of the investment unit the stock exchange does not automatically reduce the equity by the amount of the interest or principal. This is because the interest can be paid out the income of the business or investment entity. The principal is considered a loan to the business entity or investment entity. The interest paid out is tax deductible to the business entity or investment entity. The business entity cannot deduct the principal that is paid out. The interest and principal received by the shareholder of record is included in the taxable income of the shareholder of record. However, if the initial shareholder exchanged money or property ownership for the principal of the debt instrument then the principal is not included in the shareholder's taxable income because it is a repayment of a loan. This includes any shareholder not just the initial shareholder.

The preferred embodiment of the invention is an investment unit that includes one debt instrument and one share of equity. The rights of the debt instrument are issued to the share of equity. These rights include the right to the interest, the right of the principal, the right to accelerate the principal payment on default of the interest, and the right to bankrupt the corporation on default of the principal payment. One shareholder of one share of equity included in the investment unit has the right to bankrupt the corporation on default of the principal payment. Any investor can acquire one share of equity included in the investment unit even after the principal default has occurred. This is one of the ways that the HyShare overcomes the problem of joining debt and equity together contained in the Universal Casting ruling. The interest of the shareholder can be separated from the interests of the creditor.

A financial institution is chosen as an Indenture Trustee to administer the debt element of the investment unit. The debt instrument and the equity instrument are registered with Securities and Exchange Commission as an investment unit but they are registered in separate registrations. The equity will already be registered as pure equity after the debt matures. The shareholder will own the equity but will not own the debt in the investment unit. All the money or property ownership can be allocated to the equity on sale of the investment unit. The full consideration in money's worth the corporation receives in exchange for the principal will be the right to use the equity in the investment unit to maintain the corporation's own market value. The aggregate principal amount is placed on the debit side of the corporation's balance sheet as debt. The same amount is placed on the credit side of the corporation's balance sheet elimination of market value devaluation. The corporation cannot amortize the aggregate principal amount.

The equity share is listed and traded on a stock exchange. The rights of the debt instrument are traded with the equity share. The Indenture Trustee transfers the right to the interest of the debt instrument included in the new investment unit whenever the share of equity ownership is transferred to a new shareholder of record. The corporation deposits the money needed to pay the aggregate interest into an account of the financial institution that is the Indenture Trustee. The ex-interest day arrives and the owner of the equity at the beginning of trading that day included in the new investment unit of the corporation is the shareholder of record entitled to the interest payment. The equity price is not reduced artificially by the stock exchange. The market decides what the equity price is on the ex-interest date. The Indenture Trustee prepares and issues the checks on the distribution date typically two weeks after the ex-interest date.

The corporation places the aggregate interest amount on the debit side of the balance sheet as interest paid. The corporation places the aggregate interest amount on the credit side of the balance sheet as elimination of the corporation's market value devaluation. The corporation deducts the aggregate interest amount from the corporation's annual income and this reduces the corporate income tax the corporation must pay. The interest payment process is repeated every six months until the principal is paid out. The principal payment can be made anytime because the corporation does reserve the right to redeem the debt instrument earlier than the specified maturity date. Typically, the life or term of the bond of debt can be as long as thirty years. The best interest rate is one that is high around 100% but can be higher or lower.

The interest paid to the shareholder is taxable income and on the principal as well unless the initial shareholder exchanged money or property ownership for the principal. In that case the money the shareholder receives is a repayment of a loan. The corporation cannot deduct the principal from the annual taxable income in any case.

The investment unit can contain more than two instruments. Options, other securities, properties and rights can be in the investment unit along with the debt and equity. There can also be more than one debt instrument or more than one equity instrument included in the new hybrid investment unit.

The investment unit can pay dividends from the equity element in the hybrid investment unit. The debt element can pay multiple steams of interest from the same debt instrument. There can be a set interest rate that is paid and variable interest rate that is paid at the same time or at a different time. Zero coupon interest can be the companion interest that can accumulate for years while the set interest can be paid out each quarter.

The debt instrument can be issued to the outstanding equity of an investment entity or pass through entity. Even though a pass through entity is not subject to double taxation on dividends that are paid out there is often no guaranteed payment for investors. A debt instrument joined to the equity of these entities would provide a guaranteed and set payment for the investors of these entities.

Accordingly, the scope of the invention should not be limited by the embodiment(s), ramification(s), or example(s) illustrated, but encompassed by the appended claims and their legal equivalents.

What is claimed is:

1. A method of increasing the sale value of new equity of a business entity or investment entity by forming a new investment unit that includes a new division or divisions of equity of said business entity or investment entity and a new debt instrument, whereby said business entity or investment entity for the purpose of acquiring investment from possible future investors discloses in writing the specifications and facts of the operation of said new investment unit of said business entity or investment entity that includes said new division or divisions of equity and said new debt instrument, whereby said business entity or investment entity receives full consideration in money or property ownership from a initial shareholder of record of said new division or divisions of equity included in said new investment unit of said business entity or investment entity in exchange for a written unconditional promise to pay a sum certain in money on a specified date that forms the principal of said new debt instrument included in said new investment unit of said business entity or investment entity;
said business entity or investment entity forms the principal of said new debt instrument by conveying or issuing a written unconditional promise to pay a sum certain in money on a specified date,
said business entity or investment entity states in writing that until the said specified date that the principal is to be paid on arrives the interest will be paid and this forms said new debt instrument,
said business entity sells or trades said new debt instrument and said new division or divisions of said business entity or investment entity together in said new investment unit,
said business entity or investment entity prohibits both in action and in writing the said new debt instrument from being sold or traded separate from the said new division or divisions included in said new investment unit of said business entity or investment entity,
said business entity or investment entity cannot amortize the principal amount of said new debt instrument included in said new investment unit of said business entity or investment entity,
said business entity or investment entity for the purpose of acquiring investment from possible future investors discloses in writing the specifications and facts of the operation of said new investment unit of said business entity or investment entity that includes said division or divisions of equity and said new debt instrument,
said business entity or investment entity receives full consideration in money or property ownership from said initial shareholder of record of said new division or divisions of equity included in said new investment unit of said business entity or investment entity in exchange for a written unconditional promise to pay a sum certain in money on a specified date that forms the principal of said new debt instrument included in said new investment unit of said business entity or investment entity,
said initial shareholder of record of said new divisions or division of equity included in said new investment unit of said business entity or investment entity sells or trades said new division or divisions of equity included in said new investment unit of said business entity or investment entity,
said business entity or investment entity pays the principal amount of said new debt instrument included in said new investment unit of said business entity or investment entity to the shareholder of record other than the initial shareholder of record of said new division or divisions of equity included in said new investment unit of said business entity or investment entity and the principal amount paid is not included in the taxable income of the shareholder of record other than the initial shareholder of record of said new division or divisions of equity included in said new investment unit of said business entity or investment entity.

2. A method of increasing the sale value of new equity of a business entity or investment entity by forming a new investment unit that includes a division or divisions of equity ownership of said business entity and a new debt instrument, whereby the transference of the rights to both the principal of, and the stated interest on said debt instrument is entrusted to an entity other than said business entity or investment entity;
said business entity or investment entity forms the principal of said new debt instrument by conveying or issuing a written unconditional promise to pay a sum certain in money on a specified date,
said business entity or investment entity states in writing that until the said specified date that the principal is to be paid on arrives the interest will be paid and this forms said new debt instrument,
said business entity or investment entity sells or trades said new debt instrument and said division or divisions of equity ownership of said business entity together in said new investment unit,
said business entity or investment entity prohibits both in action and in writing the said new debt instrument from being sold or traded separate from the said division or divisions of equity ownership of said business entity,
said business entity or investment entity cannot amortize the principal amount of said new debt instrument included in said new investment unit of said business entity or investment entity,
a different entity other than said business or investment entity is entrusted with the transference of the rights to both the principal of, and the stated interest on said new debt instrument included in said new investment unit of said business entity,
said different entity is responsible for transferring the rights of both the principal of, and the stated interest on said new debt instrument included in said new investment unit of said business entity or investment entity to the owner of record of said division or divisions of equity ownership included in said new investment unit of said business entity or investment entity.

3. A method of paying cash to the owner of record of a division or divisions of equity ownership of a business entity or investment entity that is traded on an exchange and said exchange does not deduct the cash amount from the value or price of said division or divisions equity ownership of said business entity or investment entity;
said business entity forms the principal of said new debt instrument by conveying or issuing said written unconditional promise to pay a sum certain in money on a specified date,
said business entity or investment entity states in writing that until the said specified date that the principal is to be paid on arrives the interest will be paid and this forms said new debt instrument,
said business entity sells or trades said new debt instrument and said division or divisions of equity ownership of said business entity together in said new investment unit,
said business entity prohibits both in action and in writing the said new debt instrument from being sold or traded separate from the said division or divisions of equity ownership of said business entity,
said business entity cannot amortize the principal amount of said new debt instrument included in said new investment unit of said business entity,
said division or divisions of equity ownership of said business entity or investment entity is traded on said exchange including the said new debt instrument or including the rights to said new debt instrument in said new investment unit of said business entity or investment entity,
said business entity or investment entity pays the interest or the principal from said new debt instrument in said new investment unit of said business entity or investment entity to the owner of record of said division or divisions of equity ownership in said new investment unit of said business entity or investment entity,
said exchange does not deduct the amount of the principal or the amount of interest paid to the owner of record of said division or divisions of equity ownership included in said new investment unit of said business entity or investment entity from the value or price of said division or divisions of equity ownership in said new investment unit of said business entity or investment entity.

4. The method or process of claim 1. comprising said new debt instrument included in said new investment of said business entity or investment entity that pays at least two different interest rates or interest streams.

5. The method or process of claim 2. comprising said new debt instrument included in said new investment of said business entity or investment entity that pays at least two different interest rates or interest streams.

6. The method or process of claim 3. comprising said new debt instrument included in said new investment of said business entity or investment entity that pays at least two different interest rates or interest streams.

7. The method or process of claim 2. comprising a investment entity or pass through entity that issues the rights of said new debt instrument to outstanding division or divisions of equity ownership of said investment entity or pass through entity that forms said new investment unit and pays tax deductible interest to the owner of the outstanding division or divisions of equity ownership said investment entity or pass through entity.

8. The method or process of claim 3. comprising a investment entity or pass through entity that issues the rights of said new debt instrument to outstanding division or divisions of equity ownership of said investment entity or pass through entity that forms said new investment unit and pays tax deductible interest to the owner of the outstanding equity shares said investment entity or pass through entity.

9. The method or process of claim 1. comprising said business entity or investment entity dually registers said new debt instrument and said new division or divisions of equity ownership of said business entity or investment entity as separate elements within the single said new investment unit with the Securities and Exchange Commission.

10. The method or process of claim 2. comprising said business entity or investment entity dually registers said new debt instrument and said division of divisions of equity ownership of said business entity or investment entity as separate elements within the single said new investment unit with the Securities and Exchange Commission.

11. The method or process of claim 3. comprising said business entity or investment entity dually registers said new debt instrument and said division or divisions of equity ownership of said business entity or investment entity as separate elements within the single said new investment unit with the Securities and Exchange Commission.

12. The method or process of claim 1. comprising said business entity or investment entity issues or conveys the right to bankrupt said business entity or investment entity if said business entity or investment entity fails to pay the principal of said new debt instrument included in said new investment unit of said business entity or investment entity to the owner of record of said division or divisions of equity ownership included in said investment unit of said business entity or investment entity, whereby a majority of the owners of record of said division or divisions of equity ownership included in said investment unit of said business entity or investment entity can legally bankrupt said business entity or investment entity by voting in favor of bankrupting said business entity or investment entity for failure to pay the principal of said new debt instrument included in said new investment unit of said business entity or investment entity.

13. The method or process of claim 1. comprising said business entity or investment entity issues or conveys the right to bankrupt said business entity or investment entity if said business entity or investment entity fails to pay the principal of said new debt instrument included in said new investment unit of said business entity or investment entity to the owner of record of said new division or divisions of equity ownership included in said investment unit of said business entity or investment entity, whereby a single owner of record of one said new division or divisions of equity ownership included in said investment unit of said business entity or investment entity can legally force bankruptcy of said business entity or investment entity by filing prescribed information on the failure to pay with the bankruptcy court or other appropriate authority.

14. The method or process of claim 2. comprising said business entity or investment entity issues or conveys the right to bankrupt said business entity or investment entity if said business entity or investment entity fails to pay the principal of said new debt instrument included in said new investment unit of said business entity or investment entity to the owner of record of division or divisions of equity ownership included in said investment unit of said business entity or investment entity, whereby a majority of the owners of record of said division or divisions of equity ownership included in said investment unit of said business entity or investment entity can legally force bankruptcy of said business entity or investment entity by voting in favor of bankrupting said business entity or investment entity for failure to pay the principal of said new debt instrument included in said new investment unit of said business entity or investment entity.

15. The method or process of claim 2. comprising said business entity or investment entity issues or conveys the right to bankrupt said business entity or investment entity if said business entity or investment entity fails to pay the principal of said new debt instrument included in said new investment unit of said business entity or investment entity to the owner of record of said division or divisions of equity ownership included in said investment unit of said business entity or investment entity, whereby a single owner of record of one said division or divisions of equity ownership included in said investment unit of said business entity or investment entity can legally force bankruptcy of said business entity or investment entity by filing prescribed information on the failure to pay with the bankruptcy court or other appropriate authority.

16. The method or process of claim 3. comprising said business entity or investment entity issues or conveys the right to bankrupt said business entity or investment entity if said business entity or investment entity fails to pay the principal of said new debt instrument included in said new investment unit of said business entity or investment entity to the owner of record of said division or divisions of equity ownership included in said investment unit of said business entity or investment entity, whereby a majority of the owners of record of said division or divisions of equity ownership included in said investment unit of said business entity or investment entity can legally force bankruptcy of said business entity or investment entity by voting in favor of bankrupting said business entity or investment entity for failure to pay the principal of said new debt instrument included in said new investment unit of said business entity or investment entity.

17. The method or process of claim 3. comprising said business entity or investment entity issues or conveys the right to bankrupt said business entity or investment entity if said business entity or investment entity fails to pay the principal of said new debt instrument included in said new investment unit of said business entity or investment entity to the owner of record of said division or divisions of equity ownership included in said investment unit of said business entity or investment entity, whereby a single owner of record of one said division or divisions of equity ownership included in said investment unit of said business entity or investment entity can legally force bankruptcy of said business entity or investment entity by filing prescribed information on the failure to pay with the bankruptcy court or other appropriate authority.

18. The method or process of claim 1. comprising said new investment unit that includes said new debt instrument and said new division or divisions of equity of said business entity or investment entity, whereby said new investment unit additionally includes at least one option, security, right or any property that forms a different investment unit with at least three different elements combined.
